(19) United States
(12) Patent Application Publication
(10) Pub. No.: US 2021/0374835 A1
(43) Pub. Date: Dec. 2, 2021

(54) TRADE SERVICES PROVIDER LOCATING METHOD

(71) Applicant: Sean Waldron, Vancouver (CA)

(72) Inventor: Sean Waldron, Vancouver (CA)

(21) Appl. No.: 16/891,017

(22) Filed: Jun. 2, 2020

(51) Int. Cl. G06Q 30/06; G06Q 20/12; G06Q 30/02; G06F 8/60; H04L 29/08

(52) U.S. Cl. CPC G06Q 30/0639; G06Q 30/0605; G06Q 20/127; G06Q 30/0643; H04L 67/32; G06Q 30/0609; G06Q 30/0282; G06F 8/60; H04L 67/34; G06Q 30/0629

(57) ABSTRACT

A trade services provider locator method facilitated by a software application wherein multitude of service providers are able to be located and retained to provide a service by a requesting user. The software application of the present invention provides the service category, pricing and other parameters in addition to the geographic location of the service providers relevant to the requesting user. The geographic location of the service providers are displayed on a graphical map within the software application of the present invention wherein the icons are configured to identify the type of service that can be provided by the service provider and further identify the time window in which the service can be delivered. The user can utilize the method of the present invention to select services from more than different type of service provider simultaneously. Furthermore, the requested service can be either on-demand or for a subsequent scheduled day.

### FIELD OF THE INVENTION

The present invention relates generally to service provider locator methods, more specifically but not by way of limitation, a service provider locator software application that facilitates the identifying of a service provider and their geographic proximity to an individual wherein the software application further provides the ability to request a service.

### BACKGROUND

Trade service providers such as but not limited to plumbers and electricians are in constant demand from both commercial establishments as well as individual homeowners. Trade service providers can be identified an contacted to inquire about performing a service in various conventional methods. Some existing methods of finding and identifying a trade service provider include but are not limited to phone directories and online listing agencies and/or directories. The aforementioned provide varying levels of information about a trade service provider with a minimum being contact information and can further include service reviews. These directories are engaged to allow an individual contact the desired service provider and inquire as to whether or not the trade service provider has the capability and further what potential availability the trade service provider has over a certain time period.

While the aforementioned directories lead an individual to identify and potentially contact a desired service provider, they are lacking in automation of critical parameters that are typically required by an individual in need of a trade service provider. By way of example but not limitation, conventional directories do not provide identification of the instant geographic location of the trade service providers and the representatives thereof. Additionally, conventional methods do not provide proactively the availability of the various representatives of the trade service providers that are geographically proximate the individual requiring service.

It is intended within the scope of the present invention to provide a software application that facilitates the ability to locate a trade service provider that is geographically proximate an individual requiring service and further facilitate the review of the trade service providers availability, geographic position relative to the requesting individual and hiring of the desired trade service provider.

### SUMMARY OF THE INVENTION

It is the object of the present invention to provide a software application operable to facilitate a method of locating a trade service provider wherein the software application provides a graphical user interface compatible with a smart phone or other computing device.

Another object of the present invention is to provide a method of locating a trade service provider wherein the method of the present invention provides a graphical representation of trade service providers geographic location that are proximate the requesting individual.

A further object of the present invention is to provide a software application operable to facilitate a method of locating a trade service provider wherein the method further includes the ability to provide the availability of the trade service provider.

Still another object of the present invention is to provide a method of locating a trade service provider wherein the method of the present invention further provides identification of availability in segregated time increments.

An additional object of the present invention is to provide a software application operable to facilitate a method of locating a trade service provider wherein the method further includes the ability to preview pricing for services provided by the trade service provider.

Yet a further object of the present invention is to provide a method of locating a trade service provider wherein the method of the present invention includes categorization of the enrolled service providers.

Another object of the present invention is to provide a software application operable to facilitate a method of locating a trade service provider wherein the requesting individual can compare service pricing and reviews of two or more trade service providers that are geographically proximate to the requesting individual.

An alternate object of the present invention is to provide a method of locating a trade service provider wherein the method of the present invention further facilitates the ability for an enrolled trade service provider to accept or reject the requested service.

Still a further object of the present invention is to provide a software application operable to facilitate a method of locating a trade service provider wherein enrolled trade service providers can either pay subscription fees or membership fees to the operator of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagram of the process of the present invention from an operator perspective; and

FIG. 2 is a diagram of the process of the present invention from a user perspective.

### DETAILED DESCRIPTION

References now to the drawings submitted herewith, wherein various elements depicted therein are not necessarily drawn to scale and wherein through the views and figures like elements are referenced with identical reference numerals, there is illustrated a trade services provider locator method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

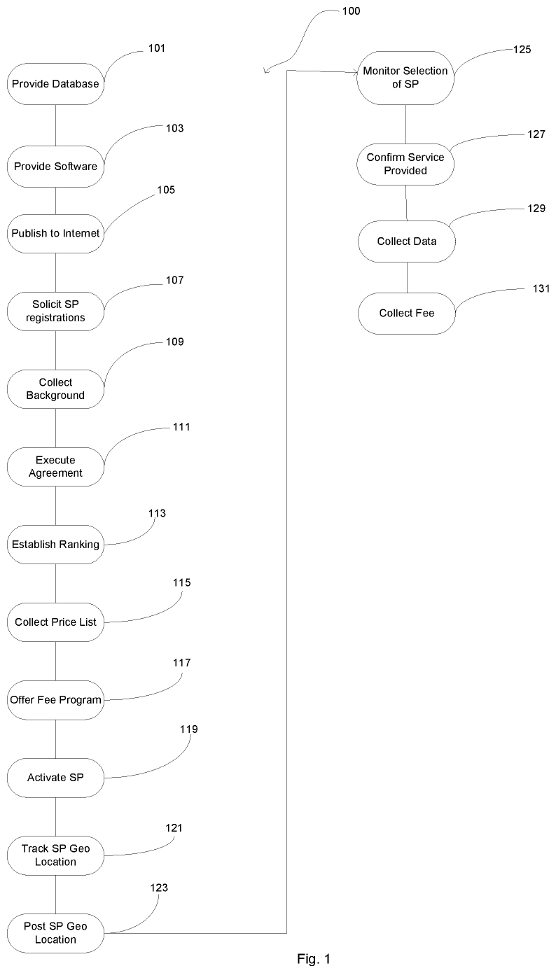

Now referring to the Drawings submitted as a part hereof, in FIG. 1 a process flow of the operator of the trade services provider locator method 100 is outlined. In step 101, the operator of the trade services provider locator method 100 will establish a computer database for operation of the trade services provider locator method 100. It should be understood within the scope of the present invention that the computer database includes the necessary computer hardware in order to facilitate execution of the process steps of the present invention as described herein. Step 103, the operator will provide the software that will facilitate the ability for the operator and users to have graphical interface with the execution of the trade services provider locator method 100. In step 105, the operator will publish the software to the Internet for use and download thereof. Step 107, the operator will solicit the registration of a multitude of service providers. It should be understood within the scope of the present invention that the operator will solicit numerous types of trades such as but not limited to plumbers, electricians, carpenters and others. The solicitation of these trades can occur in various different channels outside of the software of the present invention.

Step 109, as the operator of the present invention begins enrollment of service providers in various categories, the operator establishes a record for each wherein the relevant background information is collected. In the context of the present invention this should be understood as the collection of current copies of professional insurance, licenses and any other required certifications the at permit the service provider to execute tasks in the category for the state(s) in which they are located and requesting to be published as a service provider with the trade services provider locator method 100. In step 111, ensuing review of the data collected in step 109 and the validation thereof, the operator and the approved service provider(s) will execute a conventional terms and condition agreement that includes parameters governing the relationship therebetween. In step 113, the operator will establish an initial ranking of the service provider(s) that will be published to users along with additional information. Step 115, the operator will collect a list of services that a service provider has the capability of delivering. During this step, the service provider will further provide the pricing for each service. It should be understood within the scope of the present invention that the service provider can provide pricing wherein the pricing may be different for response time required by a requesting user. By way of example but not limitation, a service provider may have a different price for a four hour response to execute a task as compared to a twenty four hour response to execute a task.

In step 117, the operator will offer the service provider alternate types of fee programs. It is contemplated within the scope of the present invention that the operator and service providers could have various types of fee programs between the two entities for participation/enrollment of the trade services provider locator method 100. By way of example, these fee programs could be but are not limited to, the operator collects a percentage of the job performed by the service provider, the service provider pays a membership fee to be listed with the present invention or the operator has a premium subscription fee that provides the service provider various privileges and rights. Step 119, the operator will activate the service provider. Once activated the user of the software of the present invention will be able to identify, locate and engage the service provider for the services for which the service provider has establish the proper credentials. Step 121, ensuing activation of the service provider, the operator will track the location of the service provider. It should be understood within the scope of the present invention that the location of the service provider could be a single location or multiple locations. For the latter, if a service provider has a fleet of technicians, each of the location of those technicians will be tracked and reported by the operator of the present invention. Step 123, the operator will utilize the software of the trade services provider locator method 100 to post the geographic location of each of the service providers. The geographic location will be graphically available to the user utilizing an icon displayed on a geographic map wherein the map displays within a certain predetermined radius of the user such as but not limited to twenty five miles. It is contemplated within the scope of the present invention that the icons displayed could be trade specific icons in order to help the user verify the trade type. By way of example but not limitation, icons such as but not limited to could be utilized to display the geographic location of the trades wherein a lightning bolt icon could be used for and electrician and a faucet icon could be used for a plumber. Different icons for service providers allow a user to graphically identify in the event the user is looking for service from more than one service provider at the same time.

In step 125, the operator of the trade services provider locator method 100 will monitor the activity of the available service providers and identify when a user has selected a service provider to perform a service. Step 127, ensuing the delivery of the service by the service provider, the operator will receive confirmation thereof. In step 129, the operator will collect data from the user whom received the service from the service provider such as but not limited to feedback on the quality of work and timeliness. Step 131, the operator collects the fee from the user at the time of completion of the service and if applicable transfers all or a portion thereof to the service provider.

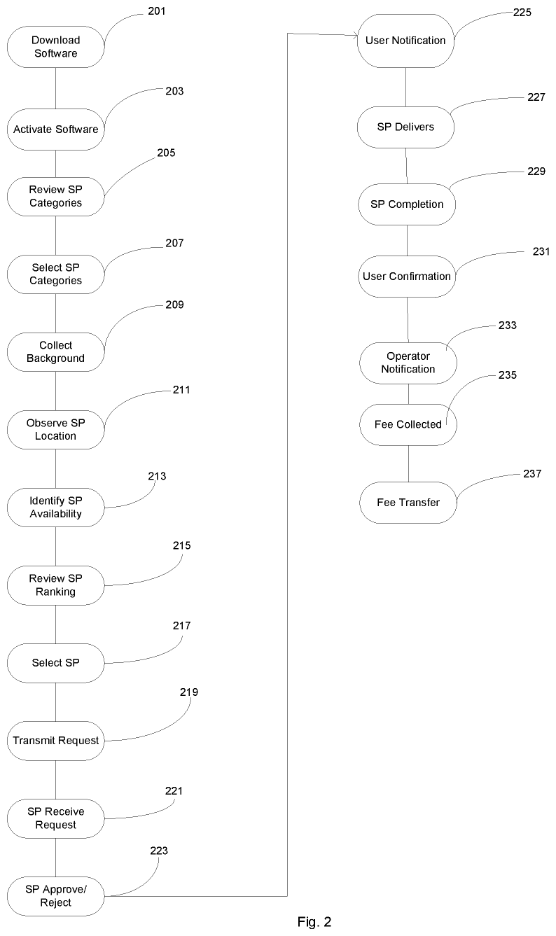

Now referring in particular to FIG. 2 submitted as a part hereof, the general process flow for a user of the trade services provider locator method 100 as facilitated by the software application is diagrammed therein. It should be understood within the scope of the present invention that the process flows diagrammed in the Figures is exemplary and that it is contemplated within the scope of the present invention that the order thereof may deviate slightly during engagement of the process of the trade services provider locator method 100. In step 201, the user will download the software application of the present invention to a suitable computing device such as but not limited to a smart phone. Step 203, the user will activate the software of the present invention. It should be understood within the scope of the present invention that the software application provides a graphical interface of various data fields such as but bot limited to account registration, trade service categories, trade service provider listing and others that facilitate the providing of information that is either required or is advantageous to a user during utilization of the software application of the present invention. In step 205, a user will review the provided service categories for which a user is in need of at least one service from a provider capable of delivering in the service category. It should be understood within the scope of the present invention that the user can select more than one type of service provider at the same time wherein the ensuing process discussed herein could be applicable to one or more service providers simultaneously.

In step 207, the will select at least one service category from a provided list of service categories. Step 209, the software application of the present invention provides a listing to the user of all of the registered service providers that are capable of delivering services in the selected category. Furthermore, in this step the user is provided with data such as but not limited to price lists, reviews and photos of the previously provided services from the service provider. Additionally, the user can be provided price comparisons for service providers in the same category for a user to review and utilize during the process of selecting a service provider. In step 211, the user will select at least one service provider and be provided the geographic location thereof so as to show the proximity of the at least one service provider to the user. The geographic location is displayed utilizing icons as previously discussed herein. Step 213, the icons utilized to display the geographic location of the service providers are further segregated to display time availability of the service providers. More specifically but not by way of limitation, it is contemplated within the scope of the present invention that the icons are color coded in order to facilitate recognition of a time period in which the service provider could arrive to the user to perform the requested service. By way of example but not limitation, the icons could be colored green if the service provider can arrive to the user within one to four hours, yellow for five to twelve hours and orange for twelve to twenty four hours. It should be understood within the scope of the present invention that numerous alternate color coding and time windows could be utilized to identify the availability of the service provider.

In step 215, the user will review the ranking of a service provider for which they may request a service. Step 217, the user will select a service provider to perform a service within a particular time window. In step 219, the software application of the present invention will transmit the service request to the service provider selected. Step 221, the service provider will receive the service request from the user. In step 223, the service provider will either accept or reject the service request. Step 225, a notification of either acceptance or rejection will be sent to the user. It should be understood within the scope of the present invention that if a service provider rejects the service request, the user will proceed back to step 205 or 207 to re-execute the process steps in finding at least one service provider. In step 227, the service provider will commute to the location of the requesting user and deliver the requested service. It should be understood within the scope of the present invention that the user can track the geographic location of the service provider while waiting for the service provider to arrive to deliver the service.

In step 229, the service provider will deliver and complete the requested service for the user. Additionally, once completed the service provider will enter the completion of the service and acceptance by the user into the software application of the trade services provider locator method 100. Step 231, the user is prompted by the software application of the present invention to confirm the completion of the service and the user executes confirmation thereof in the software application. In step 233, the user confirmation notification is transmitted to the operator of the present invention. Step 235, the user will transmit the fee for the service provided to the operator. It should be understood within the scope of the present invention that the merchant account requirements to submit and collect fees can either be executed transactional at the time of the service delivery or be automated through user account registration wherein payment method is already established for the user. In step 237, the operator will transmit the fee or a portion thereof to the service provider for the service in accordance with the fee agreement established between the operator and the service provider.

It is further contemplated within the scope of the present invention that a commercial entity could utilize the present invention to solicit bids and/or proposals from general contractors. In the aforementioned scenario, a commercial entity would upload a set of building plans to the software of the present invention wherein the service providers could subsequently provide a bid for all of the services required to complete the construction of the structure or task outlined in the uploaded plans. The commercial entity user could review the bids and select utilizing a portion of the processes described herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method of locating and procuring a service from at least one service provider comprising the steps of:
providing a software platform, said software platform being available for download to a plurality of computing devices;
enrolling a multitude of service providers, said multitude of service providers offering services in a plurality of categories;
establishing an agreement between an operator of the method and the multitude of service providers;
publishing information regarding the multitude of service providers, wherein the information regarding capabilities of the service providers is published to users of the software platform of the present invention;
reviewing service provider categories, wherein at least one user of the method reviews a provided list of service provider categories;
selecting at least one service provider category, wherein a user will select at least one category for which service is required;
reviewing a plurality of service providers in the at least one service provider category;
selecting a service provider;
displaying the geographic location of the service provider relevant to proximity of the at least one user;
requesting a service, wherein the at least one user requests a service from a service provider;
delivering a requested service, wherein a selected service provider delivers a requested service; and
wherein an operator of the method collects a fee from the at least one user for the service performed from the selected service provider.

2. The method of locating and procuring a service from at least one service provider as recited in claim 1, and further including the step of presenting trade specific graphical icons to a user searching for a service provider.

3. The method of locating and procuring a service from at least one service provider as recited in claim 2, and further including the step of identifying availability of service providers through alternate colored icons.

4. The method of locating and procuring a service from at least one service provider as recited in claim 3, and further including the step of providing the at least one user a pricing comparison of services provided by the multitude of service providers.

5. The method of locating and procuring a service from at least one service provider as recited in claim 4, and further including the step of reviewing rankings of the plurality of service providers, wherein the at least one user reviews the rankings of the plurality of service providers.

6. The method of locating and procuring a service from at least one service provider as recited in claim 5, and further including the step of providing an option of requesting a service from a service provider either on-demand or scheduled.

7. The method of locating and procuring a service from at least one service provider as recited in claim 6, and further including the step of offering memberships to the multitude of service providers, wherein the multitude of service providers pay membership fees to the operator.

8. A method operable to facilitate the review, location and procurement of a service from a licensed service provider wherein the method comprises the steps of:
providing a software platform, said software platform being published to a network for download, said software platform being downloaded to a plurality of computing devices;
enrolling a multitude of service providers, said multitude of service providers offering services in a plurality of categories;
collecting background information on the multitude of service providers, wherein an operator of the method collects and reviews information regarding the multitude of service providers;
establishing an agreement between the operator of the method and the multitude of service providers;
publishing information regarding the multitude of service providers, wherein the information regarding capabilities of the service providers is published to users of the software platform of the present invention;
logging into the software application of the present invention, wherein a user logs into and initiates use of the software application;
reviewing service provider categories, wherein the user of the method reviews a provided list of service provider categories;
selecting at least one service provider category, wherein the user will select at least one category for which service is required;
providing a plurality of service providers, wherein the user is provided with a list of service providers capable of delivering services for the at least one selected service provider category;
reviewing a plurality of service providers in the at least one service provider category, wherein the user reviews information regarding the plurality of service providers;
identifying the geographic location of the plurality of service providers;
selecting a service provider, wherein the user selects a service provider geographically proximate to the user;
displaying the geographic location of the service provider relevant to proximity of the user;
requesting a service, wherein the at least one user requests a service from a service provider;
delivering a requested service, wherein the selected service provider delivers a requested service; and
wherein an operator of the method collects a fee from the at least one user for the service performed from the selected service provider.

9. The method operable to facilitate the review, location and procurement of a service from a licensed service provider as recited in claim 8, and further including the step of providing a trade specific icon operable to identify the geographic location of a trade service provider and a type of trade capable of delivering.

10. The method operable to facilitate the review, location and procurement of a service from a licensed service provider as recited in claim 9, and further including the step of providing an icon distinction for a time period in which a service can be delivered.

11. The method operable to facilitate the review, location and procurement of a service from a licensed service provider as recited in claim 10, wherein the icon distinction for the time period is provided in alternate colors.

12. The method operable to facilitate the review, location and procurement of a service from a licensed service provider as recited in claim 11, wherein the icon distinction is alternate shapes for different service providers.

13. The method operable to facilitate the review, location and procurement of a service from a licensed service provider as recited in claim 12, and further including the step of providing the ability to schedule a service for instant on-demand or for a future date.

14. The method operable to facilitate the review, location and procurement of a service from a licensed service provider as recited in claim 13, and further including the step of providing the user pricing comparisons amongst the plurality of service providers.

15. A method operable to facilitate a review, location and procurement of services from licensed service providers wherein the method comprises the steps of:
providing a software platform, said software platform being published to a network for download, said software platform being downloaded to a plurality of computing devices;
enrolling a multitude of service providers, said multitude of service providers offering services in a plurality of categories;
collecting background information on the multitude of service providers, wherein an operator of the method collects and reviews information regarding the multitude of service providers;
establishing an agreement between the operator of the method and the multitude of service providers;
publishing information regarding the multitude of service providers, wherein the information regarding capabilities of the service providers is published to users of the software platform of the present invention;
logging into the software application of the present invention, wherein a user logs into and initiates use of the software application;
reviewing service provider categories, wherein the user of the method reviews a provided list of service provider categories;
providing a price comparison list, wherein the user can compare prices of service providers in the service provider categories;
selecting at least one service provider category, wherein the user will select at least one category for which service is required;
providing a plurality of service providers, wherein the user is provided with a list of service providers capable of delivering services for the at least one selected service provider category;
reviewing a plurality of service providers in the at least one service provider category, wherein the user reviews information regarding the plurality of service providers;
identifying the geographic location of the plurality of service providers;
providing an icon distinction for availability of the plurality of service providers;
selecting a service provider, wherein the user selects a service provider geographically proximate to the user;
transmitting a request to the selected service provider, wherein a service request is transmitted to the selected service provider;
accepting the service request, wherein the selected service provider accepts the service request;
displaying the geographic location of the service provider relevant to proximity of the user;
tracking the geographic location of the selected service provider during waiting for a service to be delivered;
delivering a requested service, wherein the selected service provider delivers a requested service;
confirming completion of the requested service, wherein the operator of the present invention receives a notification from the user of completion of the requested service; and
wherein the operator of the method collects a fee from the user for the service performed from the selected service provider.

16. The method operable to facilitate a review, location and procurement of services from licensed service providers as recited in claim 15, and further including the step of providing an icon distinction for a time period in which a service can be delivered.

17. The method operable to facilitate a review, location and procurement of services from licensed service providers as recited in claim 16, wherein the icon distinction for service providers is provided as alternate shapes of icons for different trade services.

18. The method operable to facilitate a review, location and procurement of services from licensed service providers as recited in claim 17, wherein the icon distinction for the time period is provided in alternate colors.

19. The method operable to facilitate a review, location and procurement of services from licensed service providers as recited in claim 18, and further including the step of providing alternate fee schedules between the operator and the plurality of service providers.

20. The method operable to facilitate a review, location and procurement of services from licensed service providers as recited in claim 19, and further including the step of establishing a ranking of the plurality of service providers based on feedback from a plurality users.
